(19) United States
(12) Patent Application Publication
(10) Pub. No.: US 2019/0087055 A1
(43) Pub. Date: Mar. 21, 2019

(54) MESSAGE DISPLAYING METHOD AND ELECTRONIC APPARATUS

(71) Applicant: Lenovo (Beijing) Co., Ltd., Beijing (CN)

(72) Inventors: Tiantian DONG, Beijing (CN); Difan CHEN, Beijing (CN)

(21) Appl. No.: 15/941,907

(22) Filed: Mar. 30, 2018

(30) Foreign Application Priority Data
Sep. 20, 2017 (CN) 201710855115.2

(51) Int. Cl. G06F 3/0481; G06T 11/60

(52) U.S. Cl. CPC G06F 3/0481; G06K 9/00302; G06T 11/60

(57) ABSTRACT

A method includes acquiring a message including content information and having a designated property that includes an input parameter associated with the content information, determining a message box that bears the content information based on a volume of the content information and the input parameter, and displaying the message box.

### CROSS-REFERENCES TO RELATED APPLICATION

This application claims priority to Chinese Patent Application No. 201710855115.2, filed on Sep. 20, 2017, the entire contents of which are hereby incorporated by reference.

### TECHNICAL FIELD

The present disclosure generally relates to message displaying technologies in the field of communication and, more particularly, to a message displaying method and an electronic apparatus.

### BACKGROUND

When using messages to conduct communication, the user is often bombarded by numerous repeated and complicated information. For example, the user may receive a high volume of messages within a very short period of time but fail to timely check the messages. Even assuming the user can timely check the messages, there is a high chance that the user overlooks certain important messages due to the volume and variety of the messages. For example, under a scenario where instant messaging is applied, massive voice and verbal message flows are often included in the chat boxes of two or more participators, which results in the message that needs to be emphasized or that is important not being highlighted. Thus, the user may miss or neglect certain important information.

For the user to identify the relatively important message(s) at a glance, or to highlight the message sent by the user to more easily receive enough attention from the receiver that receives the message, several solutions have been provided. The currently provided solutions, however, mostly add related descriptions or visual styles to the message after it is sent. Such kind of approaches to differentiate messages are neither sufficiently natural nor sufficiently straightforward, and the style of the message boxes remains monotonous.

### BRIEF SUMMARY OF THE DISCLOSURE

In accordance with the disclosure, there is provided a method including acquiring a message including content information and having a designated property that includes an input parameter associated with the content information, determining a message box that bears the content information based on a volume of the content information and the input parameter, and displaying the message box.

Also in accordance with the disclosure, there is provided another method including acquiring content information using an input device, obtaining a designated property that is associated with a process of inputting the content information, and generating a message based on the content information and associating the designated property with the message.

Also in accordance with the disclosure, there is provided an electronic apparatus including a processor and a display. The processor acquires a message including content information and having a designated property that includes an input parameter associated with the content information and determines a message box that bears the content information based on a volume of the content information and the input parameter. The display displays the message box.

Also in accordance with the disclosure, there is provided another electronic apparatus including an input device and a processor. The input device acquires content information. The processor obtains a designated property that is associated with a process of inputting the content information, generates a message based on the content information, and associates the designated property with the message.

### BRIEF DESCRIPTION OF THE DRAWINGS

In order to more clearly illustrate technical solutions in embodiments of the present disclosure, drawings for describing the embodiments are briefly introduced below. Obviously, the drawings described hereinafter are only some embodiments of the present disclosure, and it is possible for those ordinarily skilled in the art to derive other drawings from such drawings without creative effort.

FIG. 1 illustrates a schematic flowchart showing an example of a message displaying method;

FIG. 2 illustrates a schematic flowchart showing another example of a message displaying method;

FIG. 3 illustrates a schematic flowchart showing another example of a message displaying method;

FIG. 4 illustrates a schematic flowchart showing another example of a message displaying method;

FIG. 5 illustrates a schematic view of an example of a message box;

FIG. 6 illustrates a schematic flowchart showing another example of a message displaying method;

FIG. 7 illustrates a schematic view of another example of a message box;

FIG. 8 illustrates a schematic view showing an example of a structure of an electronic apparatus; and

FIG. 9 illustrates a schematic view showing another example of a structure of an electronic apparatus.

### DETAILED DESCRIPTION

Various solutions and features of the present disclosure will be described hereinafter with reference to the accompanying drawings. It should be understood that, various modifications may be made to the embodiments described below. Thus, the specification shall not be construed as limiting, but is to provide examples of the disclosed embodiments. Further, in the specification, descriptions of well-known structures and technologies are omitted to avoid obscuring concepts of the present disclosure.

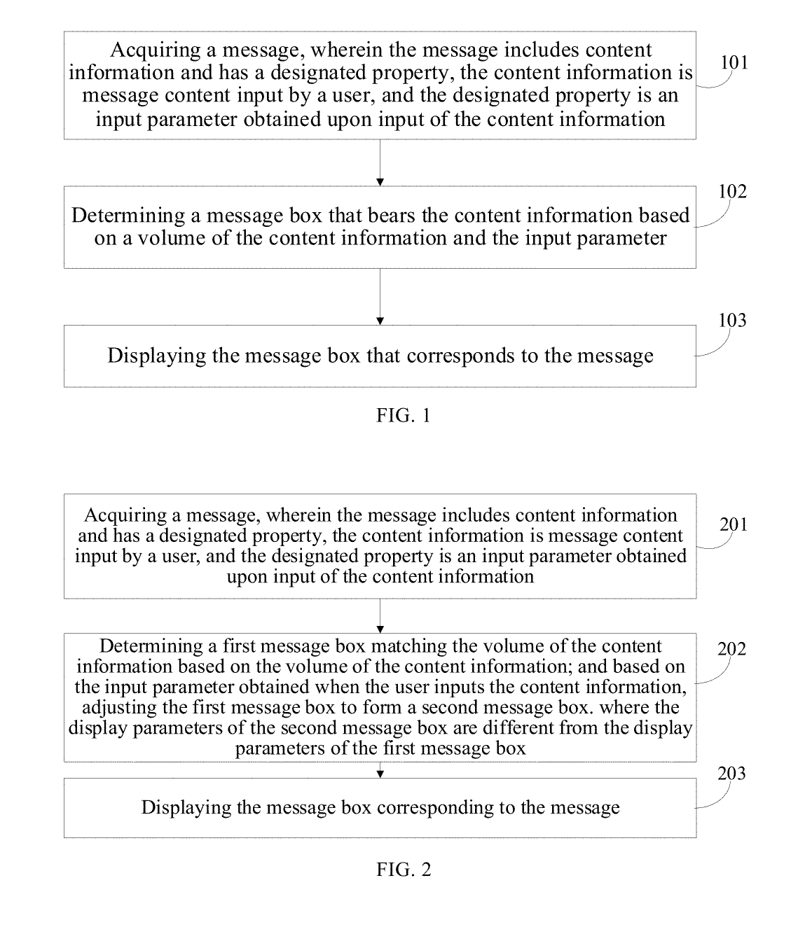

FIG. 1 illustrates a schematic flowchart showing an example of a message displaying method. As shown in FIG. 1, the message displaying method includes followings.

At S101, a message is acquired, where the message includes content information, and the content information is message content input by a user. The message may have a designated property, and the designated property can be an input parameter obtained when the user inputs the content information.

The disclosed technical solutions may be applied to a terminal, and the terminal may be a device, such as a cellphone, a tablet, or a notebook. The terminal may include an application (APP) for performing message interaction with other terminals. The APP may include but not limited to instant messaging APP, text APP, mail APP, etc.

Further, no matter whether it is the local terminal that acquires the message, or it is the opposite terminal that acquires the message, the message can be both displayed at the local terminal and the opposite terminal. In descriptions provided hereinafter, examples showing the local terminal to display the acquired message are usually given for illustrative purposes. However, when it is the opposite terminal that acquires the message, the aforementioned method may be similarly applied, and the displaying manner of the message may be synchronized to the local terminal through forwarding by a server or a direct connection between the opposite terminal and the local terminal.

In some embodiments, the message acquired by the terminal includes content information, and the content information is message content input by a user. Further, the message has designated properties, where the designated properties are input parameter obtained when the user inputs the content information. The content information and the designated property of the message may be determined using one of the example approaches described below.

In one approach, input content may be acquired through an input device, and the input content is the content input by the user that is to be sent. A sensor may be applied to acquire the input parameter during a process of the user inputting the input content. Further, a sending command may be acquired. When the sending command is acquired, the input content is used as content information of the message, and the input parameter obtained when the user inputs the content information is used as the designated property of the message.

The aforementioned input device may need to have a function of collecting content information. For example, the input device may include a touch screen, a keyboard, or a voice collecting device. Further, the aforementioned sensor may need to have an input parameter collecting function. For example, the sensor may include a camera, a pressure sensor, or a voice collecting device.

In some embodiments, the input device and the sensor are two individual devices, for example, the input device and the sensor may include a touch screen and a camera, respectively. In some other embodiments, the input device and the sensor may be integrated in one device, for example, the input device may include a touch screen and the sensor may include a pressure sensor integrated in the touch screen. In some other embodiments, the input device and the sensor may be the same device, such as the voice collecting device.

The input content may be acquired through the input device, and the input content may be content input by the user that is to be sent. The input content herein may include verbal content or voice content.

In some embodiments, the input content includes the verbal content. In these embodiments, the input parameter obtained during the process of the user inputting the input content may include: 1) collection parameters of a facial expression of the user during the process of the user inputting the input content; 2) values of forces applied by the user on corresponding keys of a keyboard during the process of the user inputting the input content. The keyboard may be a physical keyboard or a virtual keyboard.

Further, the collection parameters of the facial expression of the user may be acquired by a camera. The camera may capture the face of the user and analyze the captured image to determine the type of facial expression of the user, such as happy, extremely excited, angry, and excited.

The values of the forces applied by the user on the corresponding keys of the keyboard may be detected by a sensor, and the sensor may be a force or pressure sensor at a bottom side of the keyboard. For example, when the user clicks the keyboard (a physical or virtual keyboard), the pressure sensor at the bottom of the keyboard may collect the value of the force that the user applies on the corresponding key. Further, each word may correspond to a force value, where the force value may be, for example, an average value of the forces applied by the user on corresponding keys during the process of inputting the word. Accordingly, the verbal content (e.g., a sentence or paragraph) may correspond to a group of force values.

In some other embodiments, the type of input content is voice content. Under such situations, the input parameter obtained during the process of the user inputting the input content may include one or more of the following: 1) a value of a pressure applied by the user on a voice input control that is configured to maintain the operation of a voice input collecting function during the process of the user inputting the input content; 2) collection parameters of the facial expression of the user during the process of the user inputting the input content; 3) parameter information of the user's voice during the process of the user inputting the input content through voice input.

For example, in some embodiments, the input parameter may include a value of a pressure applied by the user on a voice input control during the process of the user inputting the input content. For the user to input voice data, the user often needs to press and hold the voice input control. During the process of the voice input control being pressed and held, the voice input collection function can be realized, such that the voice data input by the user may be collected. Further, when the user presses and holds the voice input control, the value of the pressure applied by the user on the voice input control may be collected and recorded as the input parameter.

In some other embodiments, the input parameter may include collection parameters of the facial expression of the user during the process of the user inputting the input content. The collection parameters of the facial expression of the user may be acquired by a camera. The camera may capture an image of the face of the user and analyze the captured image to determine the type of the facial expression of the user, such as happy, extremely excited, angry, and excited.

In some other embodiments, the input parameter may include parameter information of the user's voice during the process of the user inputting the input content. During the process of the user inputting the input content via voice input, the voice of the user may vary continuously, which can be reflected by the continuous variance in the volume and frequency of the voice. Based on this, a voice collection device may be used to collect the volume information or the frequency information of the user.

In another approach of determining the content information and the designated property of the message, input content may be acquired through an input device, where the input content is the content input by the user that is to be sent; and an input operation directed to a sending control is acquired. Further, in response to the input operation that is directed to the sending control, the input content is used as the content information of the message, the input parameter of the input operation by the user directed to the sending control is determined, and the input parameter of the input operation by the user directed to the sending control is used as the designated property of the message.

The input content may be acquired through the input device, and the input content may be content input by the user that is to be sent. The input content herein may include verbal content or voice content. The input parameter of the input operation directed to the sending control may be, for example, a value of the pressure exerted by the user on the sending control when input of the input content is completed.

At S102, a message box bearing the content information is determined based on a volume of the content information and the input parameter obtained when the user inputs the content information.

In some embodiments, the content information includes verbal information. In these embodiments, the volume of the content information refers to the amount of verbal information. The message box needs to display the specific verbal information, and the display manner of the message box is not only related to the volume of the verbal information, but also related to the input parameter(s) of the verbal information.

In one application scenario, the volume of the verbal information is related to the dimension of the message box. The greater the volume of the verbal information is, the greater the dimension of the message box can be. Further, the input parameter is related to the display effects of the message box. Given the input parameter being a value of a pressure on the sending control as an example, the greater the value of the pressure is, the darker the background color of the message box can be.

In another example, the input parameter may be a value of the force applied by the user on a key of the keyboard during the process of the user inputting the content information. In this example, the lower side of the message box may be a straight line, and the upper side of the message box may vary dynamically based on the value of the force corresponding to each word, which forms a continuous curve that represents the variance in the value of the force.

In some other embodiments, the content information includes voice information, and the volume of the content information refers to the duration of the voice message. The specific voice information does not need to be displayed at the message box, and the display manner of the message box is not only related to the volume of the voice information but is also related to the input parameter of the voice information.

In one application scenario, the volume of the voice information is related to the dimension of the message box. The greater the volume of the audio information is, the greater the dimension of the message box can be.

Further, the input parameter may be related to the display effects of the message box. Given the value of pressure on the sending control as an example, the greater the pressure is, the darker the background color of the message box can be. In another example, the input parameter may be a value of the force applied by the user on a key of the keyboard during the process of the user inputting the content information. In this example, the lower side of the message box may be a straight line, and the upper side of the message box may vary dynamically based on the value of the force corresponding to each word, which forms a continuous curve that represents the variance in the value of the force. In another example, the input parameter may be parameter information of the user's voice, the lower side of the message box may be a straight line, and the upper side of the message box may vary dynamically based on the volume of the voice collected during the voice collection process to form a continuous curve that can represent the variance in the volume of the user's voice.

Further, the display manner of the message box is not limited thereto. For example, the display manner of the message box may be determined through the facial expression of the user. For example, if the facial expression collected by the camera is seriousness, a dark color may be applied to fill the background of the message box. As another example, if the facial expression collected by the camera is happy, a bright color may be applied to fill the background of the message box.

In some other embodiments, a certain image or image icon (e.g., an emoticon or emoji) may be superimposed on top of the message box to represent the facial expression of the user. For example, a smiling emoji or a bombardment icon may be superimposed on the message box.

At S103, the message box corresponding to the message is displayed.

In some embodiments, the process to display information is to display the message box that bears the content information on an interface, e.g., a chat dialogue interface. For the verbal message, when the message box is displayed, the user may directly see the verbal content. For the voice message, no voice content can be visually seen within the message box, and it is from the display manner of the message box that the user determines the status of the user (e.g., happy or angry) when inputting the voice message. Accordingly, whether the voice message is an important message or a message that requires attention may be determined.

FIG. 2 illustrates a schematic flowchart showing another example of a message displaying method. As shown in FIG. 2, a message displaying method may include the followings.

At S201, a message is acquired, where the message includes content information, and the content information is input by a user. The message may include a designated property, and the designated property may include an input parameter obtained when the user inputs the content information. In some embodiments, the message may include a plurality of designated properties, and the present disclosure is not limited thereto. The content information and the designated property of the message may be determined using one of the example approaches described below.

In one approach, input content may be acquired through an input device, and the input content is the content input by the user that is to be sent. A sensor may be applied to acquire the input parameter during a process of the user inputting the input content. When acquiring a sending command, the input content may be used as the content information of the message, and the input parameter obtained when the user inputs the content information may be used as the designated property of the message.

Here, the input device needs to have a function of collecting content information, and the input device can include a touch screen, a keyboard, or a voice collecting device. The sensor may need to have an input parameter collecting function. For example, the sensor may include a camera, a pressure sensor, or a voice collecting device.

In some embodiments, the input device and the sensor are two individual devices, for example, the input device and the sensor may include a touch screen and a camera, respectively. In some other embodiments, the input device and the sensor may be integrated in one device, for example, the input device may include a touch screen and the sensor may include a pressure sensor integrated in the touch screen. In some other embodiments, the input device and the sensor may be the same device, such as the voice collecting device.

The input content may be acquired through the input device, and the input content may be content input by the user that is to be sent. The input content here may refer to verbal content or voice content.

In some embodiments, the input content includes the verbal content. In these embodiments, the input parameter obtained during the process of the user inputting the input content may include: 1) collection parameters of a facial expression of the user during the process of the user inputting the input content; 2) values of forces applied by the user on corresponding keys of a keyboard during the process of the user inputting the input content. The keyboard may be a physical keyboard or a virtual keyboard.

Further, the collection parameters of the facial expression of the user may be acquired by a camera. The camera may capture the face of the user and analyze the captured image to determine the type of facial expression of the user, such as happy, extremely excited, angry, and excited.

The values of the forces applied by the user on the corresponding keys of the keyboard may be detected by a sensor, and the sensor may be a force or pressure sensor at a bottom side of the keyboard. For example, when the user clicks the keyboard (a physical or virtual keyboard), the pressure sensor at the bottom of the keyboard may collect the value of the force that the user applies on the corresponding key. Further, each word may correspond to a force value, where the force value may be, for example, an average value of the forces applied by the user on corresponding keys during the process of the user inputting the word. Accordingly, the verbal content (e.g., a sentence or paragraph) may correspond to a group of force values.

In some other embodiments, the type of input content is voice content. Under such situations, the input parameter during the process of the user inputting the input content may be one or more of following types: 1) a value of a pressure applied by the user on a voice input control that is configured to maintain the running of a voice input collecting function during the process of the user inputting the input content; 2) collection parameters of the facial expression of the user during the process of the user inputting the input content; 3) parameter information of the user's voice during the process of the user inputting the input content through voice input.

For example, in some embodiments, the input parameter may include a value of a pressure applied by the user on a voice input control during the process of the user inputting the input content. For the user to input voice data, the user often needs to press and hold the voice input control. During the process of the voice input control being pressed and held, the voice input collection function can be realized, such that the voice data input by the user may be collected. Further, when the user presses and holds the voice input control, the value of the pressure applied by the user on the voice input control may be collected and recorded as the input parameter.

In some other embodiments, the input parameter may include collection parameters of the facial expression of the user during the process of the user inputting the input content. The collection parameters of the facial expression of the user may be acquired by a camera. The camera may capture an image of the face of the user and analyze the captured image to determine the type of the facial expression of the user, such as happy, extremely excited, angry, and excited.

In some other embodiments, the input parameter may include parameter information of the user's voice during the process of the user inputting the input content. During the process of the user inputting the input content via voice input, the voice of the user may vary continuously, which can be reflected by the continuous variance in the volume and frequency of the voice. Based on this, a voice collection device may be used to collect the volume information or the frequency information of the user.

In another approach of determining the content information and the designated property of the message, input content may be acquired through an input device, where the input content is the content input by the user that is to be sent; and an input operation directed to a sending control is acquired. Further, in response to the input operation that is directed to the sending control, the input content is used as the content information of the message, the input parameter of the input operation by the user directed to the sending control is determined, and the input parameter of the input operation by the user directed to the sending control is used as the designated property of the message.

The input content may be acquired through the input device, and the input content may be content input by the user that is to be sent. The input content herein may refer to verbal content or voice content. The input parameter of the input operation directed to the sending control may be, for example, a value of the pressure exerted by the user on the sending control when input of the input content is completed.

At S202, a first message box matching the volume of the content information is determined based on the volume of the content information; and based on the input parameter obtained when the user inputs the content information, the first message box is adjusted to form a second message box. The display parameters of the second message box are different from the display parameters of the first message box.

In some embodiments, the content information includes the verbal information. In these embodiments, the volume of the content information refers to the amount of verbal information. The message box needs to display the specific verbal information, and the display manner of the message box is not only related to the volume of the verbal information, but also related to the input parameter(s) of the verbal information.

In one application scenario, the volume of the verbal information is related to the dimension of the message box. The greater the volume of the verbal information is, the greater the dimension of the message box can be, and based on the volume of the verbal information, the first message box is determined. Further, the input parameter may be related to the display effect of the message box. More specifically, the second message box may be formed by adjusting the first message box based on the input parameter. The display parameters of the second message box are different from the display parameters of the first message box. The display parameters include one or more of the following parameters: dimension, shape, background color, and animation displaying effects.

In one example, the background color of the first message box may be adjusted based on the input parameter. The input parameter may be a value of a pressure applied by the user on the sending control, and the greater the value of the pressure is, the darker the background color of the message box can be.

In another example, the input parameter may be a value of the force applied by the user on a key of the keyboard during the process of the user inputting the content information. In this example, the lower side of the message box may be a straight line, and the upper side of the message box may vary dynamically based on the value of the force corresponding to each word, which forms a continuous curve that represents the variance in the value of the force.

In some other embodiments, the content information includes voice information, and the volume of the content information refers to the duration of the voice message. The specific voice information does not need to be displayed at the message box, and the display manner of the message box is not only related to the volume of the voice information but is also related to the input parameter of the voice information.

In one application scenario, the volume of the voice information is related to the dimension of the message box. The greater the volume of the voice information is, the greater the dimension of the message box can be, and the first message box may be determined based on the volume of the voice information.

Further, the input parameter may be related to the display effects of the message box. More specifically, the second message box may be formed by adjusting the first message box based on the input parameter. The display parameters of the second message box are different from the display parameters of the first message box. The display parameters include one or more of the following parameters: dimension, shape, background color, and animation displaying effects.

In one example, the input parameter includes the value of pressure applied on the sending control, and the greater the pressure is, the darker the background color of the message box can be. In another example, the input parameter may be the value of the pressure applied on a voice input control. In this example, the lower side of the message box may be a straight line and the upper side of the message box may vary dynamically based on the value of the pressure applied on the voice input control during the voice collecting process, which forms a continuous curve that can represent the variance in the value of the pressure.

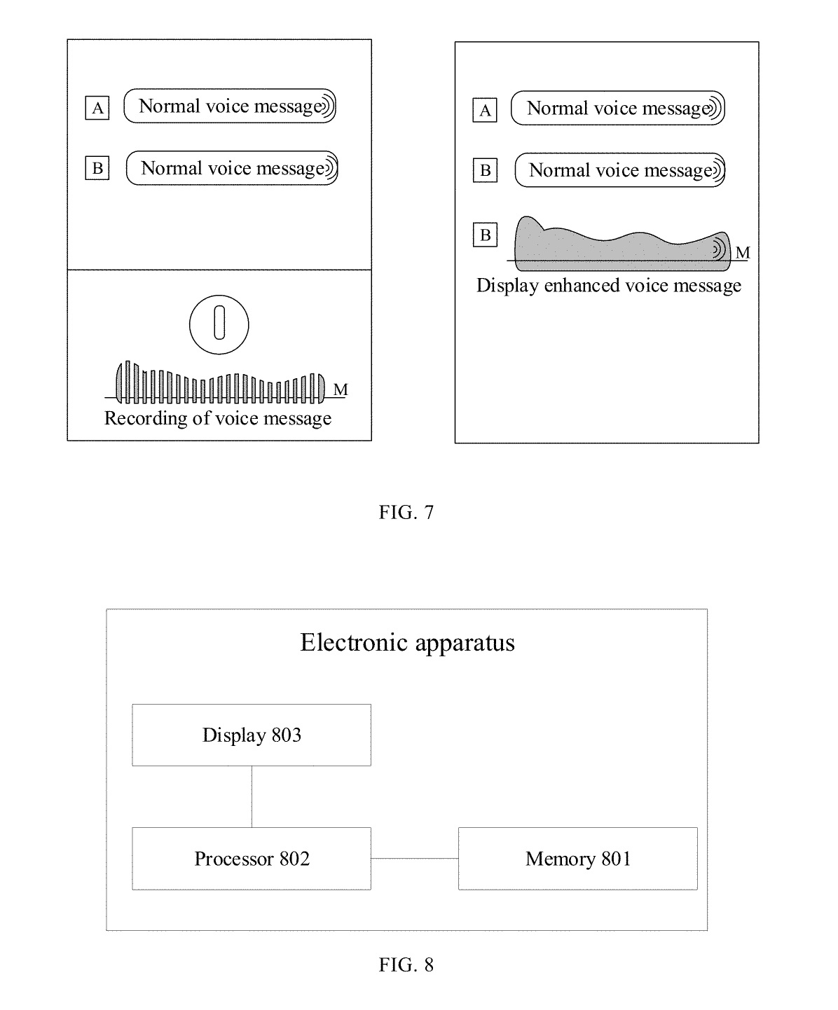

In another example, the input parameter is the parameter information of the user's voice. In this example, the lower side of the message box may be a straight line and the upper side of the message box may vary dynamically based on the volume of the voice collected during the voice collecting process, which forms a continuous curve that can represent the variance in the volume of the voice, as shown in FIG. 7.

At S203, the message box corresponding to the message is displayed.

In some embodiments, the process to display information is to display the message box that bears the content information on an interface, e.g., a chat dialogue interface. For the verbal message, when the message box is displayed, the user may directly see the verbal content. For the voice message, no voice content can be visually seen within the message box, and it is from the display manner of the message box that the user determines the status of the user (e.g., happy or angry) when inputting the voice message. Accordingly, whether the voice message is an important message or a message that requires attention may be determined.

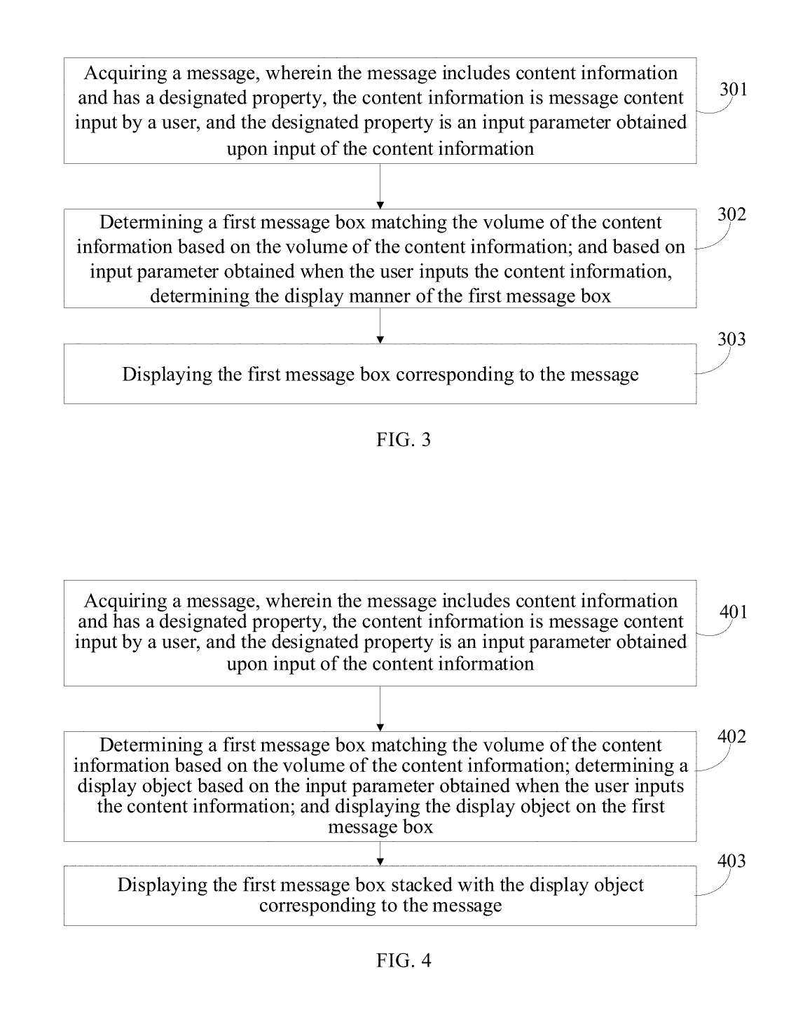

FIG. 3 illustrates a schematic flowchart showing another example of a message displaying method. As shown in FIG. 3, a message displaying method includes followings.

At S301, a message is acquired, where the message includes content information, and the content information is input by a user. The message may include a designated property, and the designated property may include an input parameter obtained when the user inputs the content information. Further, the content information and the designated property of the message may be determined using one of the example approaches described below.

In one approach, input content may be acquired through an input device, and the input content is the content input by the user that is to be sent. A sensor may be applied to acquire the input parameter during a process of the user inputting the input content. Further, a sending command may be acquired. When the sending command is acquired, the input content is used as content information of the message, and the input parameter obtained when the user inputs the content information is used as the designated property of the message.

The aforementioned input device may need to have a function of collecting content information. For example, the input device may include a touch screen, a keyboard, or a voice collecting device. Further, the aforementioned sensor may need to have an input parameter collecting function. For example, the sensor may include a camera, a pressure sensor, or a voice collecting device.

In some embodiments, the input device and the sensor are two individual devices, for example, the input device and the sensor may include a touch screen and a camera, respectively. In some other embodiments, the input device and the sensor may be integrated in one device, for example, the input device may include a touch screen and the sensor may include a pressure sensor integrated in the touch screen. In some other embodiments, the input device and the sensor may be the same device, such as the voice collecting device.

The input content may be acquired through the input device, and the input content may be content input by the user that is to be sent. The input content herein may include verbal content or voice content.

In some embodiments, the input content includes the verbal content. In these embodiments, the input parameter obtained during the process of the user inputting the input content may include: 1) collection parameters of a facial expression of the user during the process of the user inputting the input content; 2) values of forces applied by the user on corresponding keys of a keyboard during the process of the user inputting the input content. The keyboard may be a physical keyboard or a virtual keyboard.

Further, the collection parameters of the facial expression of the user may be acquired by a camera. The camera may capture the face of the user and analyze the captured image to determine the type of facial expression of the user, such as happy, extremely excited, angry, and excited.

The values of the forces applied by the user on the corresponding keys of the keyboard may be detected by a sensor, and the sensor may be a force or pressure sensor at a bottom side of the keyboard. For example, when the user clicks the keyboard (a physical or virtual keyboard), the pressure sensor at the bottom of the keyboard may collect the value of the force that the user applies on the corresponding key. Further, each word may correspond to a force value, where the force value may be, for example, an average value of the forces applied by the user on corresponding keys during the process of inputting the word. Accordingly, the verbal content (e.g., a sentence or paragraph) may correspond to a group of force values.

In some other embodiments, the type of input content is voice content. Under such situations, the input parameter obtained during the process of the user inputting the input content may include following one or more of the following: 1) a value of a pressure applied by the user on a voice input control that is configured to maintain the operation of a voice input collecting function during the process of the user inputting the input content; 2) collection parameters of the facial expression of the user during the process of the user inputting the input content; 3) parameter information of the user's voice during the process of the user inputting the input content through voice input.

For example, in some embodiments, the input parameter may include a value of a pressure applied by the user on a voice input control during the process of the user inputting the input content. For the user to input voice data, the user often needs to press and hold the voice input control. During the process of the voice input control being pressed and held, the voice input collection function can be realized, such that the voice data input by the user may be collected. Further, when the user presses and holds the voice input control, the value of the pressure applied by the user on the voice input control may be collected and recorded as the input parameter.

In some other embodiments, the input parameter may include collection parameters of the facial expression of the user during the process of the user inputting the input content. The collection parameters of the facial expression of the user may be acquired by a camera. The camera may capture an image of the face of the user and analyze the captured image to determine the type of the facial expression of the user, such as happy, extremely excited, angry, and excited.

In some other embodiments, the input parameter may include parameter information of the user's voice during the process of the user inputting the input content. During the process of the user inputting the input content via voice input, the voice of the user may vary continuously, which can be reflected by the continuous variance in the volume and frequency of the voice. Based on this, a voice collection device may be used to collect the volume information or the frequency information of the user.

In another approach of determining the content information and the designated property of the message, input content may be acquired through an input device, where the input content is the content input by the user that is to be sent; and an input operation directed to a sending control is acquired. Further, in response to the input operation that is directed to the sending control, the input content is used as the content information of the message, the input parameter of the input operation by the user directed to the sending control is determined, and the input parameter of the input operation by the user directed to the sending control is used as the designated property of the message.

The input content may be acquired through the input device, and the input content may be content input by the user that is to be sent. The input content herein may include verbal content or voice content. The input parameter of the input operation directed to the sending control may be, for example, a value of the pressure exerted by the user on the sending control when input of the input content is completed.

At S302, a first message box matching the volume of the content information is determined based on the volume of the content information; and based on input parameter obtained when the user inputs the content information, the display manner of the first message box is determined.

In some embodiments, the content information includes verbal information. In these embodiments, the volume of the content information refers to the amount of verbal information. The message box needs to display the specific verbal information, and the display manner of the message box is not only related to the volume of the verbal information, but also related to the input parameter(s) of the verbal information.

In one application scenario, the volume of the verbal information is related to the dimension of the message box. The greater the volume of the verbal information is, the greater the dimension of the message box can be, and based on the volume of the verbal information, the first message box is determined. Further, the input parameter may be related to the display effect of the message box. More specifically, the display manner of the first message box may be determined based on the input parameter obtained when the user inputs the content information. For example, the display manner may include which color or which style of the line is applied to display the frame of the first message box.

In some other embodiments, the content information includes voice information, and the volume of the content information refers to the duration of the voice message. The specific voice information does not need to be displayed at the message box, and the display manner of the message box is not only related to the volume of the voice information but is also related to the input parameter of the voice information.

In one application scenario, the volume of the voice information is related to the dimension of the message box. The greater the volume of the voice information is, the greater the dimension of the message box can be, and the first message box may be determined based on the volume of the voice information.

Further, the input parameter may be related to the display effects of the message box. More specifically, the display manner of the first message box may be determined based on the input parameter obtained when the user inputs the content information. For example, the display manner may include which color or which style of the line is applied to display the frame of the first message box.

At S303, the first message box corresponding to the message is displayed.

In some embodiments, the process to display information is to display the message box that bears the content information on an interface, e.g., a chat dialogue interface. For the verbal message, when the message box is displayed, the user may directly see the verbal content. For the voice message, no voice content can be visually seen within the message box, and it is from the display manner of the message box that the user determines the status of the user (e.g., happy or angry) when inputting the voice message. Accordingly, whether the voice message is an important message or a message that requires attention may be determined.

FIG. 4 illustrates a schematic flowchart showing another example of a message displaying method. As shown in FIG. 4, a message displaying method includes the followings.

At S401, a message is acquired, where the message includes content information, and the content information is input by a user. The message may include a designated property, and the designated property may include an input parameter obtained when the user inputs the content information. Further, the content information and the designated property of the message may be determined using one of the example approaches described below.

In one approach, input content may be acquired through an input device, and the input content is the content input by the user that is to be sent. A sensor may be applied to acquire the input parameter during a process of the user inputting the input content. Further, a sending command may be acquired. When the sending command is acquired, the input content is used as content information of the message, and the input parameter obtained when the user inputs the content information is used as the designated property of the message.

The aforementioned input device may need to have a function of collecting content information. For example, the input device may include a touch screen, a keyboard, or a voice collecting device. Further, the aforementioned sensor may need to have an input parameter collecting function. For example, the sensor may include a camera, a pressure sensor, or a voice collecting device.

In some embodiments, the input device and the sensor are two individual devices, for example, the input device and the sensor may include a touch screen and a camera, respectively. In some other embodiments, the input device and the sensor may be integrated in one device, for example, the input device may include a touch screen and the sensor may include a pressure sensor integrated in the touch screen. In some other embodiments, the input device and the sensor may be the same device, such as the voice collecting device.

The input content may be acquired through the input device, and the input content may be content input by the user that is to be sent. The input content herein may include verbal content or voice content.

In some embodiments, the input content includes the verbal content. In these embodiments, the input parameter obtained during the process of the user inputting the input content may include: 1) collection parameters of a facial expression of the user during the process of the user inputting the input content; 2) values of forces applied by the user on corresponding keys of a keyboard during the process of the user inputting the input content. The keyboard may be a physical keyboard or a virtual keyboard.

Further, the collection parameters of the facial expression of the user may be acquired by a camera. The camera may capture the face of the user and analyze the captured image to determine the type of facial expression of the user, such as happy, extremely excited, angry, and excited.

The values of the forces applied by the user on the corresponding keys of the keyboard may be detected by a sensor, and the sensor may be a force or pressure sensor at a bottom side of the keyboard. For example, when the user clicks the keyboard (a physical or virtual keyboard), the pressure sensor at the bottom of the keyboard may collect the value of the force that the user applies on the corresponding key. Further, each word may correspond to a force value, where the force value may be, for example, an average value of the forces applied by the user on corresponding keys during the process of inputting the word. Accordingly, the verbal content (e.g., a sentence or paragraph) may correspond to a group of force values.

In some other embodiments, the type of input content is voice content. Under such situations, the input parameter obtained during the process of the user inputting the input content may include following one or more of the following: 1) a value of a pressure applied by the user on a voice input control that is configured to maintain the operation of a voice input collecting function during the process of the user inputting the input content; 2) collection parameters of the facial expression of the user during the process of the user inputting the input content; 3) parameter information of the user's voice during the process of the user inputting the input content through voice input.

For example, in some embodiments, the input parameter may include a value of a pressure applied by the user on a voice input control during the process of the user inputting the input content. For the user to input voice data, the user often needs to press and hold the voice input control. During the process of the voice input control being pressed and held, the voice input collection function can be realized, such that the voice data input by the user may be collected. Further, when the user presses and holds the voice input control, the value of the pressure applied by the user on the voice input control may be collected and recorded as the input parameter.

In some other embodiments, the input parameter may include collection parameters of the facial expression of the user during the process of the user inputting the input content. The collection parameters of the facial expression of the user may be acquired by a camera. The camera may capture an image of the face of the user and analyze the captured image to determine the type of the facial expression of the user, such as happy, extremely excited, angry, and excited.

In some other embodiments, the input parameter may include parameter information of the user's voice during the process of the user inputting the input content. During the process of the user inputting the input content via voice input, the voice of the user may vary continuously, which can be reflected by the continuous variance in the volume and frequency of the voice. Based on this, a voice collection device may be used to collect the volume information or the frequency information of the user.

In another approach of determining the content information and the designated property of the message, input content may be acquired through an input device, where the input content is the content input by the user that is to be sent; and an input operation directed to a sending control is acquired. Further, in response to the input operation that is directed to the sending control, the input content is used as the content information of the message, the input parameter of the input operation by the user directed to the sending control is determined, and the input parameter of the input operation by the user directed to the sending control is used as the designated property of the message.

The input content may be acquired through the input device, and the input content may be content input by the user that is to be sent. The input content herein may include verbal content or voice content. The input parameter of the input operation directed to the sending control may be, for example, a value of the pressure exerted by the user on the sending control when input of the input content is completed.

At S402, a first message box matching the volume of the content information is determined based on the volume of the content information; a display object is determined based on the input parameter obtained when the user inputs the content information; and the display object is superimposed on the first message box.

In some embodiments, the content information includes verbal information. In these embodiments, the volume of the content information refers to the amount of verbal information. The message box needs to display the specific verbal information, and the display manner of the message box is not only related to the volume of the verbal information, but also related to the input parameter(s) of the verbal information.

In one application scenario, the volume of the verbal information is related to the dimension of the message box. The greater the volume of the verbal information is, the greater the dimension of the message box can be.

In some other embodiments, the content information includes voice information, and the volume of the content information refers to the duration of the voice message. The specific voice information does not need to be displayed at the message box, and the display manner of the message box is not only related to the volume of the voice information but is also related to the input parameter of the voice information.

In one application scenario, the volume of the voice information is related to the dimension of the message box. The greater the volume of the voice information is, the greater the dimension of the message box can be.

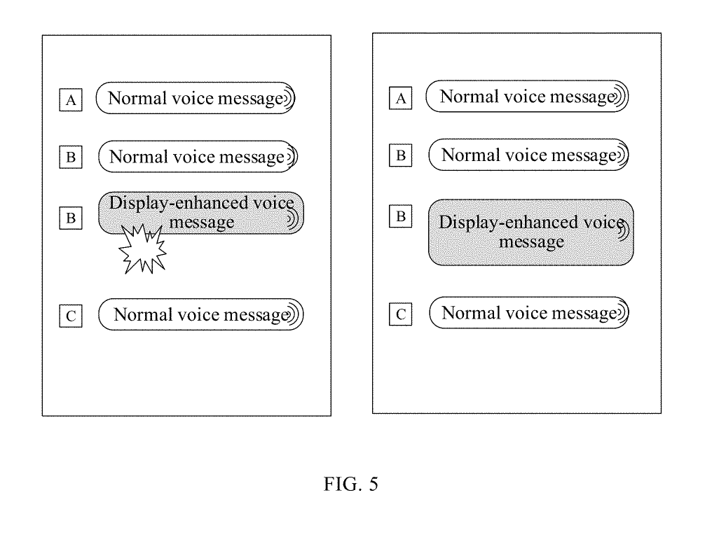

Further, the display manner of the message box is also related to the input parameter. Based on the input parameter, a certain display object (e.g., an image icon) may be determined, and the display object may be displayed on the first message box that matches the volume of the content information. Given the input parameter being collection information of the facial expression of the user as an example, when the collected facial expression is seriousness, a bombardment icon may be superimposed on the first message box, as shown in FIG. 5. When the collected facial expression indicates happiness, a smiling emoji may be superimposed on the first message box.

At S403, the first message box corresponding to the message is displayed, with the display object being shown on the first message box.

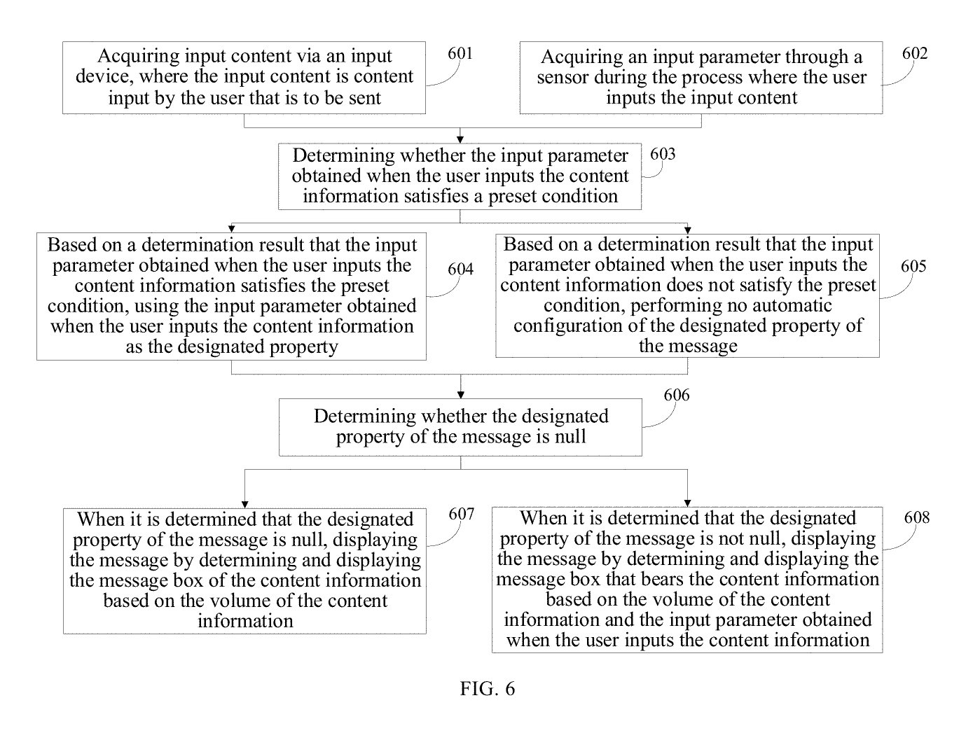

FIG. 6 illustrates a schematic flowchart showing another example of a message displaying method. As shown in FIG. 6, a message displaying method includes the followings.

At S601, input content is acquired via an input device, where the input content is content input by the user that is to be sent.

At S602, an input parameter is acquired through a sensor during the process of the user inputting the input content.

At S603, whether the input parameter obtained when the user inputs the content information satisfies a preset condition is determined.

The input parameter herein may correspond to a preset threshold. For example, the input parameter may be a value of a pressure applied on the sending control. When the value of the pressure exceeds a preset threshold, the value of the pressure applied on the sending control may be used as the designated property of the message. When the value of the pressure does not exceed the preset threshold, the designated property of the message is set to be null.

At S604: based on a determination result that the input parameter obtained when the user inputs the content information satisfies the preset condition, the input parameter obtained when the user inputs the content information is used as the designated property of the message.

When acquiring the sending command, the input content may be used as the content information of the message, and the input parameter obtained when the user inputs the content information may be used as the designated property of the message.

At S605, based on a determination result that the input parameter obtained when the user inputs the content information does not satisfy the preset condition, the designated property of the message is not automatically configured.

At S606, whether the designated property of the message is null is determined

At S607, when it is determined that the designated property of the message is null, the message is displayed by determining and displaying the message box of the content information based on the volume of the content information.

At S608, when it is determined that the designated property of the message is not null, the message is displayed by determining and displaying the message box that bears the content information based on the volume of the content information and the input parameter obtained when the user inputs the content information.

According to the present disclosure, the messages can be divided into two types. For the first type of messages, a message box that bears the content information is determined based on the volume of the content information. For the second type of messages, a message box that bears the content information is determined based on the volume of the content information and the input parameter obtained when the user inputs the content information. When the message box of each message is displayed in such a manner, the user may directly notice which messages are messages with enhanced display and which messages are messages without enhanced display (i.e., normal messages).

FIG. 8 illustrates a schematic view showing an example of a structure of an electronic apparatus. As shown in FIG. 8, the electronic apparatus includes a memory 801, a processor 802, and a display 803. The memory 801 is configured to store a message displaying command. The processor 802 is configured to execute the message displaying command stored in the memory 801, thereby executing following functions.

That is, the processor 802 may acquire a message, where the message includes content information, and the content information is input by a user. The message may include a designated property, and the designated property may include an input parameter obtained when the user inputs the content information. The processor 802 may further determine a message box bearing the content information, based on a volume of the content information and the input parameter obtained when the user inputs the content information.

Further, the display 803 is configured to display the message box corresponding to the message. Those skilled in the relevant art shall understand that the functions implemented by each component of the electronic apparatus may be understood in detail with reference to the related descriptions provided in the disclosed message displaying method.

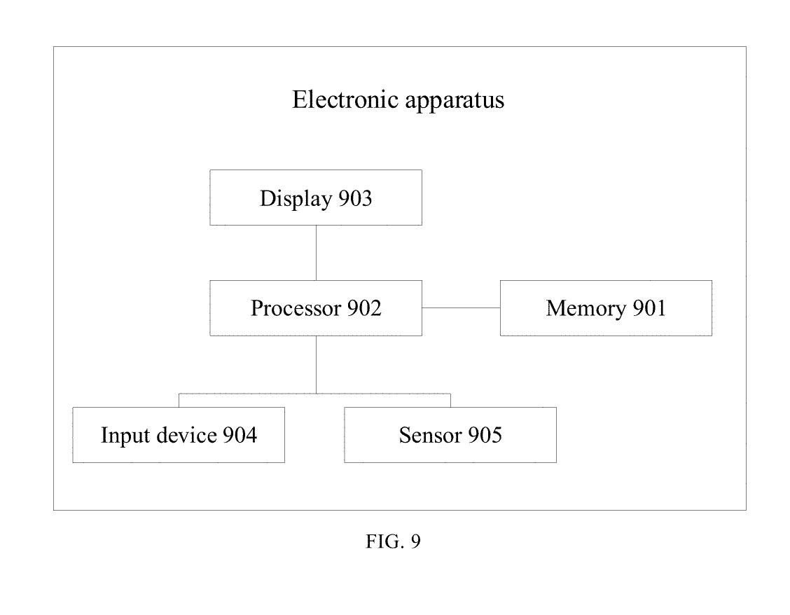

FIG. 9 illustrates a schematic view showing another example of a structure of an electronic apparatus. As shown in FIG. 9, the electronic apparatus includes a memory 901, a processor 902, and a display 903. The memory 901 is configured to store a message displaying command. The processor 902 is configured to execute the message displaying command stored in the memory 901, thereby executing following functions.

That is, the processor 902 may acquire a message, where the message includes content information, and the content information is input by a user. The message may include a designated property, and the designated property may include an input parameter obtained when the user inputs the content information. The processor 902 may further determine a message box bearing the content information, based on volume of the content information and the input parameter obtained when the user inputs the content information. Further, the display 903 is configured to display the message box corresponding to the message.

In some embodiments, the processor 902 may be configured to determine a first message box matching the volume of the content information based on the volume of the content information. The processor 902 may further adjust the first message box based on the input parameter obtained when the user inputs the content information to form a second message box. The display parameters of the second message box are different from the display parameters of the first message box.

In some other embodiments, the processor 902 may be configured to, based on the volume of the content information, determine the first message box matching the volume of the content information, and based on the input parameter obtained when the user inputs the content information, determine a display manner of the first message box.

In some other embodiments, the processor 902 may be configured to determine the first message box that matches the volume of the content information based on the volume of the content information, determine a display object based on the input parameter obtained when the user inputs the content information, and superimpose the display object on the first message box.

In some embodiments, the input parameter obtained when the user inputs the content information may be a value of pressure applied on a sending control when the input of the content information by the user is completed. In some other embodiments, the input parameter obtained when the user inputs the content information may be a value of a pressure applied by the user on a voice input control that is configured to maintain the operation of a voice input collecting function during the process of the user inputting the input content.

In some other embodiments, the input parameter obtained when the user inputs the content information may be collection parameters of the facial expression of a user during a process of the user inputting the input content. In some other embodiments, the input parameter obtained during the process of the user inputting the input content may include a value of a force applied by the user on a corresponding key when the user presses the keyboard to input the input content. In some other embodiments, the input parameter obtained during the process of the user inputting the input content may include parameter information of the user's voice during the process of the user inputting the input content via voice input.

In some embodiments, as shown in FIG. 9, the electronic apparatus further includes the input device 904, and the sensor 905. The input device 904 is configured to acquire input content, where the input content is the content input by the user that is to be sent. The sensor 905 is configured to acquire the input parameter(s) input by the user during the process of the user inputting the input content. The processor 902 is further configured to, when acquiring a sending command, use the input content as content information of the message, and use the input parameter(s) obtained when the user inputs the content information as the designated property of the message.

In some other embodiments, the input device 904 may acquire the input content, where the input content is the content input by the user that is to be sent. The processor 902 may be further configured to acquire an input operation directed to a sending control, and in response to the input operation that is directed to the sending control, use the input content as the content information of the message. The processor 902 may further determine the input parameter of the input operation by the user directed to the sending control and use the input parameter of the input operation by the user directed to the sending control as the designated property of the message.

In some other embodiments, the processor 902 may further determine whether the input parameter obtained when the user inputs the content information satisfy a preset condition. Based on a determination result that the input parameter obtained when the user inputs the content information satisfies the preset condition, the processor 902 may use the input parameter obtained when the user inputs the content information as the designated property of the message. Based on a determination result that the input parameter obtained when the user inputs the content information does not satisfy the preset condition, the processor 902 does not automatically configure the designated property of the message.

Further, the processor 902 may determine whether the designated property of the message is null. When it is determined that the designated property of the message is null, processor 902 may determine the message box of the content information based on the volume of the content information. When it is determined that the designated property of the message is not null, the processor 902 determines the message box that bears the content information based on the volume of the content information and the input parameter obtained when the user inputs the content information.

Those skilled in the relevant art shall understand that the functions implemented by each component of the electronic apparatus displayed in FIG. 9 may be understood with reference to the related descriptions in the disclosed message displaying method.

Those skilled in the relevant art shall understand that the implementation functions of each unit in the electronic apparatus may be understood with reference to the related description in the disclosed message displaying method.

In various embodiments of the present disclosure, it should be understood that the disclosed method, device and apparatus may be implemented by other manners. That is, the device described above is merely for illustrative. For example, the units may be merely partitioned by logic function. In practice, other partition manners may also be possible. For example, various units or components may be combined or integrated into another system, or some features may be omitted or left unexecuted. Further, mutual coupling or direct coupling or communication connection displayed or discussed therebetween may be via indirect coupling or communication connection of some communication ports, devices, or units, in electrical, mechanical or other manners.

Units described as separate components may or may not be physically separate, and the components serving as display units may or may not be physical units. That is, the components may be located at one position or may be distributed over various network units. Optionally, some or all the units may be selected to realize the purpose of solutions of embodiments herein according to practical needs. Further, each functional unit in each embodiment of the present disclosure may be integrated in one processing unit, or each unit may exist physically and individually, or two or more units may be integrated in one unit.

When the described functions are implemented as software function units, and are sold or used as independent products, they may be stored in a computer accessible storage medium. Technical solutions of the present disclosure may be embodied in the form of a software product. The computer software product may be stored in a storage medium and include several instructions to instruct a computer device (e.g., a personal computer, a server, or a network device) to execute all or some of the method steps of each embodiment. The storage medium described above may include portable storage device, ROM, RAM, a magnetic disc, an optical disc or any other media that may store program codes.

The foregoing is only specific implementation methods of the present disclosure, and the protection scope of the present disclosure is not limited thereto. Without departing from the technical scope of the present disclosure, variations or replacements obtainable by anyone skilled in the relevant art shall all fall within the protection scope of the present disclosure. The protection scope of the subject disclosure is therefore to be limited only by the scope of the appended claims.

What is claimed is:

1. A method comprising:
acquiring a message, wherein the message includes content information and has a designated property that includes an input parameter associated with the content information;
determining a message box that bears the content information based on a volume of the content information and the input parameter; and
displaying the message box.

2. The method according to claim 1, wherein determining the message box includes:
determining the message box that matches the volume of the content information based on the volume of the content information; and
changing a display parameter of the message box based on the input parameter.

3. The method according to claim 1, wherein determining the message box includes:
determining the message box that matches the volume of the content information based on the volume of the content information; and
determining a display manner of the message box based on the input parameter.

4. The method according to claim 1, wherein determining the message box includes:
determining the message box that matches the volume of the content information based on the volume of the content information;
determining a display object based on the input parameter; and
superimposing the display object on the message box.

5. The method according to claim 1, wherein the input parameter is selected from a group consisting of:
a value of a pressure exerted on a sending control at an end of a process of inputting the content information,
a value of a pressure applied on a voice input control during the process of inputting the content information,
a parameter related to a facial expression collected during the process of inputting the content information,
a value of a force applied on a key of a keyboard during the process of inputting the content information, and
voice parameter information collected during the process of inputting the content information.

6. A method comprising:
acquiring, using an input device, content information;
obtaining a designated property that is associated with a process of inputting the content information; and
generating a message based on the content information and associating the designated property with the message.

7. The method of claim 6, wherein obtaining the designated property includes:
acquiring, using a sensor during the process of inputting the content information, an input parameter as the designated property.

8. The method according to claim 7, wherein acquiring the input parameter as the designated property includes:
determining whether the input parameter satisfies a preset condition; and
in response to the input parameter satisfying the preset condition, determining the input parameter as the designated property.

9. The method of claim 6, wherein obtaining the designated property includes:
detecting an operation directed to a sending control at the end of the process of inputting the content information; and
in response to the operation directed to the sending control, acquiring an input parameter of the operation directed to the sending control as the designated property.

10. An electronic apparatus comprising:
a processor, wherein the processor:
acquires a message, the message including content information and having a designated property that includes an input parameter associated with the content information, and
determines a message box that bears the content information based on a volume of the content information and the input parameter; and
a display, wherein the display displays the message box.

11. The electronic apparatus according to claim 10, wherein the processor further:
determines the message box that matches the volume of the content information based on the volume of the content information, and
changes a display parameter of the message box based on the input parameter.

12. The electronic apparatus according to claim 10, wherein the processor further:
determines the message box that matches the volume of the content information based on the volume of the content information; and
determines a display manner of the message box based on the input parameter.

13. The electronic apparatus according to claim 10, wherein the processor further:
determines the message box that matches the volume of the content information based on the volume of the content information;
determines a display object based on the input parameter; and
superimposes the display object on the message box.

14. The electronic apparatus according to claim 10, wherein the input parameter is selected from a group consisting of:
a value of a pressure exerted on a sending control at an end of a process of inputting the content information,
a value of a pressure applied on a voice input control during the process of inputting the content information,
a parameter related to a facial expression collected during the process of inputting the content information,
a value of a force applied on a key of a keyboard during the process of inputting the content information, and
voice parameter information collected during the process of inputting the content information.

15. An electronic apparatus comprising:
an input device, wherein the input device acquires content information; and
a processor, wherein the processor:
obtains a designated property that is associated with a process of inputting the content information; and
generates a message based on the content information and associates the designated property with the message.

16. The electronic apparatus according to claim 15, further comprising:
a sensor, wherein the sensor acquires, during the process of inputting the content information, an input parameter,
wherein the processor further determines the input parameter as the designated property.

17. The electronic apparatus according to claim 16, wherein the processor determines the input parameter as the designated property by:
determining whether the input parameter satisfies a preset condition; and
in response to the input parameter satisfying the preset condition, determining the input parameter as the designated property.
